(19) United States
(12) Patent Application Publication
(10) Pub. No.: US 2020/0139342 A1
(43) Pub. Date: May 7, 2020

(54) METAL-ORGANIC FRAMEWORK, METHOD FOR PREPARING THE SAME, AND ADSORPTION DEVICE EMPLOYING THE SAME

(71) Applicant: Industrial Technology Research Institute, Hsinchu (TW)

(72) Inventors: Wei-Chih LEE, Kaohsiung City (TW); Chang-Yi SHEN, Zhubei City (TW); Jiun-Jen CHEN, New Taipei City (TW); Yuhao KANG, Zhubei City (TW); Shih-Yun YEN, New Taipei City (TW)

(73) Assignee: Industrial Technology Research Institute, Hsinchu (TW)

(21) Appl. No.: 16/214,600

(22) Filed: Dec. 10, 2018

(30) Foreign Application Priority Data
Nov. 5, 2018 (TW) 107139167

(51) Int. Cl. B01J 20/22; B01J 20/30; B01J 20/28; B01D 53/26; B01D 53/02

(52) U.S. Cl. CPC B01J 20/226; B01J 20/3078; B01J 20/28066; B01D 2257/80; B01D 53/261; B01D 53/02; B01D 2253/204; B01J 20/28016

(57) ABSTRACT

A metal organic framework and a method for preparing the same, and an adsorption device employing the metal organic framework are provided. The metal organic framework includes a 3,5-pyridinedicarboxylic acid and a metal ion, which is an aluminum ion, a chromium ion, or a zirconium ion, wherein the 3,5-pyridinedicarboxylic acid is coordinated to the metal ion.

### CROSS REFERENCE TO RELATED APPLICATIONS

The application is based on, and claims priority from, Taiwan Application Serial Number 107139167, filed on Nov. 05, 2018, the disclosure of which is hereby incorporated by reference herein in its entirety.

### TECHNICAL FIELD

The disclosure relates to a metal-organic framework and a method for preparing the same, and in particular to a metal-organic framework with a great water adsorption amount under a low relative humidity.

### BACKGROUND

Moisture-adsorbent materials are widely used in the adsorption dryers of compressed-air systems. After passing through an air compressor, the introduced ambient air has a relative humidity above 80%. Thus, most of the moisture content of the introduced ambient air must be removed by a freeze dryer, and then the remaining moisture content of the introduced ambient air is removed by an adsorption dryer. After being treated with the freeze dryer, the introduced ambient air has a relative humidity less than 30%. The compressed air is then treated with the adsorption dryer to remove the remaining moisture content. Therefore, the moisture-adsorbent materials employed by the adsorption dryer should exhibit a high water adsorption amount under extremely low relative humidity, thereby lessening the equipment size, reducing the construction cost, and improving the operational efficiency.

Conventional moisture-adsorbent materials like zeolite 4A exhibit a good water adsorption amount under low relative humidity. The high hydrophilicity of zeolite 4A increases the difficulty of moisture desorption. In general, the moisture adsorbed by zeolite 4A would be desorbed therefrom at a temperature of about 140° C.-160° C. or more. However, moisture desorption performed at high temperatures will not only cause a large amount of energy to be consumed as a result of the regeneration of moisture-adsorbent materials, but also increases inconvenience during use. In view of this, there has been an increasing demand for moisture-adsorbent materials that can adsorb moisture at a low relative humidity and desorb moisture at low temperatures.

Conventional moisture-adsorbent materials, however, exhibit low water adsorption amounts at a low relative humidity. Furthermore, moisture adsorbed by conventional moisture-adsorbent materials would be desorbed therefrom at a temperature above 140° C. As a result, the energy consumption and operating cost of the device employing the conventional moisture-adsorbent materials are increased.

Accordingly, a novel metal-organic framework is required to solve the aforementioned problems.

### SUMMARY

According to embodiments of the disclosure, the disclosure provides a metal-organic framework. The metal-organic framework includes a 3,5-pyridinedicarboxylic acid and a metal ion, wherein the 3,5-pyridinedicarboxylic acid is coordinated to the metal ion. In particular, the metal ion is an aluminum ion, a chromium ion, or a zirconium ion.

According to another embodiment of the disclosure, the disclosure provides a method for preparing the metal-organic framework. The method for preparing the metal-organic framework includes providing a composition, wherein the composition includes a 3,5-pyridinedicarboxylic acid, a metal compound, and an organic solvent. Next, the composition is subjected to a heating process, so that the 3,5-pyridinedicarboxylic acid reacts with the metal compound, obtaining a metal-organic framework.

According to another embodiment of the disclosure, the disclosure also provides an adsorption device. The adsorption device includes a carrier and an adsorption material. In particular, the adsorption material is disposed on the carrier. The adsorption material can be the aforementioned metal-organic framework.

A detailed description is given in the following embodiments with reference to the accompanying drawings.

### BRIEF DESCRIPTION OF THE DRAWINGS

FIG. 1 shows the thermogravimetric analysis (TGA) curves of the metal-organic framework of Preparation Example 1.

FIG. 2 shows the isothermal adsorption curve of the metal-organic framework of Preparation Example 1.

FIG. 3 is a graph plotting the water adsorption amount of the metal-organic framework of Preparation Example 1, Basolite® A520, active alumina and zeolite 4A powder against various relative humidity levels.

FIG. 4 is a graph plotting the water adsorption amount of the metal-organic framework of Preparation Example 1 and Basolite® A520 (under a relative humidity of 30%) against time.

FIG. 5 is a graph plotting the water adsorption amount of the metal-organic framework of Preparation Example 1 (under a relative humidity of 80%) against time.

FIG. 6 is a schematic view of an adsorption device according to an embodiment of the disclosure.

### DESCRIPTION

In the following detailed description, for the purposes of explanation, numerous specific details are set forth in order to provide a thorough understanding of the disclosed embodiments. It will be apparent, however, that one or more embodiments may be practiced without these specific details. In other instances, well-known structures and devices are shown schematically in order to simplify the drawing.

Embodiments of the disclosure provide a metal-organic framework, a method for preparing the same, and an adsorption device employing the metal-organic framework. The metal-organic framework of the disclosure exhibits a rapid water adsorption property under a low relative humidity. Herein, the term “low relative humidity” refers to the atmosphere having a relative humidity of 30% and the atmosphere having a temperature of 25° C. The metal-organic framework can be further disposed on a carrier to obtain an adsorption device. The adsorption device can be used in an adsorption dryer to achieve the desired rapid water adsorption property under a low relative humidity.

According to embodiments of the disclosure, the disclosure provides a metal-organic framework. The metal-organic framework includes a 3,5-pyridinedicarboxylic acid and a metal ion, wherein the 3,5-pyridinedicarboxylic acid is coordinated to the metal ion. In particular, the metal ion is an aluminum ion, a chromium ion, or a zirconium ion. The molar ratio of 3,5-pyridinedicarboxylic acid to the metal ion is from 3:1 to 1:2. When the molar ratio of 3,5-pyridinedicarboxylic acid to the metal ion is less than 1:2, the metal-organic framework exhibits a low water adsorption amount since the metal-organic framework would not be a porous material. When the molar ratio of 3,5-pyridinedicarboxylic acid to the metal ion is greater than 3:1, the metal-organic framework also exhibits a low water adsorption amount since the metal-organic framework would not be a porous material.

According to embodiments of the disclosure, the disclosure provides a method for preparing the aforementioned metal-organic framework. First, a composition is provided, wherein the composition includes a 3,5-pyridinedicarboxylic acid, a metal compound, and an organic solvent. Next, after uniformly mixing the composition, the composition is subjected to a heating process so that the 3,5-pyridinedicarboxylic acid reacts with the metal compound, obtaining a metal-organic framework.

According to embodiments of the disclosure, wherein the molar ratio of 3,5-pyridinedicarboxylic acid to the metal ion is from 3:1 to 1:2, such as 2:1 or 1:1.

According to embodiments of the disclosure, wherein the metal compound can be aluminum salt, chromium salt, zirconium salt, or a combination thereof. In particular, the metal compound can be aluminum nitrate, aluminum phosphate, chromium nitrate, chromium phosphate, zirconium nitrate, zirconium phosphate, zirconyl chloride, or a combination thereof.

According to embodiments of the disclosure, the metal compound in the composition has an initial concentration from 0.16 mol/L to 0.33 mol/L, based on the volume of the organic solvent. According to another embodiment of the disclosure, the composition can further include water. According to embodiments of the disclosure, the metal compound in the composition has an initial concentration from 0.16 mol/L to 0.33 mol/L, based on the volume of the organic solvent and water.

According to embodiments of the disclosure, the organic solvent can be N,N-dimethylformamide, N,N-diethylformamide, N,N-dimethylacetamide, or a combination thereof.

According to another embodiment of the disclosure, wherein the composition can further include water. According to embodiments of the disclosure, the volume ratio of the organic solvent to water is from 1:29 to 2:1 (such as from 1:29 to 1:4 or from 1:29 to 1:2). According to some embodiments of the disclosure, when the volume ratio of the organic solvent to water in the composition is too low (for example the volume ratio of the organic solvent to water is less than 1:29), the metal-organic framework exhibits a low water adsorption amount. For example, there is no metal-organic framework obtained after subjecting the composition to the heating process, when the composition does not include organic solvent.

According to embodiments of the disclosure, the heating process can have a temperature from about 100° C. to 150° C., such as from 120° C. to 140° C. In addition, the heating process can be performed for a period of 12 hrs to 66 hrs, such as from 45 hrs to 48 hrs.

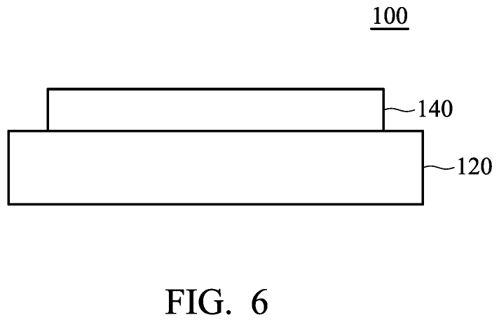

According to embodiments of the disclosure, as shown in FIG. 6, the disclosure provides an adsorption device 100. The adsorption device 100 includes a carrier 120 and an adsorption material 140. The adsorption material can be disposed on the carrier. The adsorption material can include a 3,5-pyridinedicarboxylic acid and a metal ion, wherein the 3,5-pyridinedicarboxylic acid is coordinated to the metal ion. In particular, the metal ion is an aluminum ion, a chromium ion, or a zirconium ion. According to embodiments of the disclosure, the adsorption material exhibits a water adsorption amount from 18 wt % to 40 wt % after disposing the adsorption device under a relative humidity of 30% at 25° C. for 30 minutes.

Herein, the water adsorption amount in the disclosure is determined using the following equation:

$$water absorption amount = \frac{{W}_{1} - {W}_{0}}{{W}_{0}} \times 100 \% ,$$

wherein W₁ refers to the weight of the adsorption material after water adsorption, and W_{O} refers to the weight of the adsorption material after water desorption at 80° C.

According to embodiments of the disclosure, the adsorption material can be used under a low relative humidity. Furthermore, the adsorption material can be used in an adsorption dryer such as high-pressure air dryer or plastic dryer. Moreover, the adsorption material can serve as an adsorbent for removing specific harmful small-molecule compound or gas.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Preparation of Metal-Organic Framework

### Preparation Example 1

First, aluminum nitrate (Al(NO₃)₃.9H₂O) (0.015 mol), 3,5-pyridinedicarboxylic acid (0.015mol), water (72 mL) and dimethylformamide (18 mL) were mixed, wherein the molar ratio of the 3,5-pyridinedicarboxylic acid to the aluminum nitrate was 1:1. Next, the mixture was stirred at 120° C. for 48 hrs. Next, after cooling to room temperature, yellow sediment was collected. After washing the yellow sediment with water and filtering, a yellow solid was obtained. Next, the yellow solid was dried with a dryer (having a drying temperature of about 140° C.) overnight. After drying, the yellow solid was ground into powder. Next, the powder was subjected to a vacuum drying process in a vacuum drying oven, wherein the temperature of the vacuum drying process was about 140° C., and the vacuum drying process was performed for a period of 6 hrs. After cooling to room temperature, a metal-organic framework (yellowish powder) (1) was obtained. The characteristics of the metal-organic framework (1) were determined by a specific surface area and porosimetry analyzer. The metal-organic framework (1) had a specific surface area of 1133 m²/g and a water adsorption amount of 34.48 wt %. The water adsorption amount was determined using the following equation:

$$water absorption amount = \frac{{W}_{1} - {W}_{0}}{{W}_{0}} \times 100 \% ,$$

wherein W₁ was the weight of the adsorption material after water adsorption, and W_{O} was the weight of the adsorption material after water desorption at 80° C.

### Preparation Example 2

Preparation Example 2 was performed in the same manner as Preparation Example 1 except that the molar ratio of the 3,5-pyridinedicarboxylic acid to the aluminum nitrate was increased from 1:1 to 2:1, obtaining a metal-organic framework (2). The metal-organic framework (2) had a water adsorption amount of 34.96 wt %.

### Preparation Example 3

Preparation Example 3 was performed in the same manner as Preparation Example 1 except that the molar ratio of the 3,5-pyridinedicarboxylic acid to the aluminum nitrate was increased from 1:1 to 3:1, obtaining a metal-organic framework (3). The metal-organic framework (3) had a water adsorption amount of 33.81 wt %.

### Preparation Example 4

Preparation Example 4 was performed in the same manner as Preparation Example 1 except that the molar ratio of the 3,5-pyridinedicarboxylic acid to the aluminum nitrate was increased from 1:1 to 4:1, obtaining a metal-organic framework (4). The metal-organic framework (4) had a water adsorption amount of 13.4 wt %.

### Preparation Example 5

Preparation Example 5 was performed in the same manner as Preparation Example 1 except that the molar ratio of the 3,5-pyridinedicarboxylic acid to the aluminum nitrate was reduced from 1:1 to 1:2, obtaining a metal-organic framework (5). The metal-organic framework (5) had a water adsorption amount of 28.42 wt %.

### Preparation Example 6

Preparation Example 6 was performed in the same manner as Preparation Example 1 except that the molar ratio of the 3,5-pyridinedicarboxylic acid to the aluminum nitrate was reduced from 1:1 to 1:3, obtaining a metal-organic framework (6). The metal-organic framework (6) had a water adsorption amount of 17.85 wt %.

### Preparation Example 7

Preparation Example 7 was performed in the same manner as Preparation Example 1 except that the amount of water was increased from 72 mL to 87 mL and the amount of dimethylformamide was reduced from 18 mL to 3 mL, obtaining a metal-organic framework (7). The metal-organic framework (7) had a water adsorption amount of 34.90 wt %.

### Preparation Example 8

Preparation Example 8 was performed in the same manner as Preparation Example 1 except that the amount of water was increased from 72 mL to 81 mL and the amount of dimethylformamide was reduced from 18 mL to 9 mL, obtaining a metal-organic framework (8). The metal-organic framework (8) had a water adsorption amount of 35.20 wt %.

### Preparation Example 9

Preparation Example 9 was performed in the same manner as Preparation Example 1 except that the amount of water was increased from 72 mL to 76.5 mL and the amount of dimethylformamide was reduced from 18 mL to 13.5 mL, obtaining a metal-organic framework (9). The metal-organic framework (9) had a water adsorption amount of 34.30 wt %.

### Preparation Example 10

Preparation Example 10 was performed in the same manner as Preparation Example 1 except that the amount of water was increased from 72 mL to 75 mL and the amount of dimethylformamide was reduced from 18 mL to 15 mL, obtaining a metal-organic framework (10). The metal-organic framework (10) had a water adsorption amount of 35.66 wt %.

### Preparation Example 11

Preparation Example 11 was performed in the same manner as Preparation Example 1 except that the amount of water was reduced from 72 mL to 67.5 mL and the amount of dimethylformamide was increased from 18 mL to 22.5 mL, obtaining a metal-organic framework (11). The metal-organic framework (11) had a water adsorption amount of 34.99 wt %.

### Preparation Example 12

Preparation Example 12 was performed in the same manner as Preparation Example 1 except that the amount of water was reduced from 72 mL to 54 mL and the amount of dimethylformamide was increased from 18 mL to 36 mL, obtaining a metal-organic framework (12). The metal-organic framework (12) had a water adsorption amount of 31.17 wt %.

### Preparation Example 13

Preparation Example 13 was performed in the same manner as Preparation Example 1 except that the amount of water was reduced from 72 mL to 30 mL and the amount of dimethylformamide was increased from 18 mL to 60 mL, obtaining a metal-organic framework (13). The metal-organic framework (13) had a water adsorption amount of 29.61 wt %.

### Preparation Example 14

Preparation Example 14 was performed in the same manner as Preparation Example 1 except that 72 mL of water and 18 mL of dimethylformamide were replaced with 90 mL of dimethylformamide, obtaining a metal-organic framework (14). The metal-organic framework (14) had a water adsorption amount of 20.94 wt %.

### Preparation Example 15

Preparation Example 15 was performed in the same manner as Preparation Example 1 except that aluminum nitrate was replaced with aluminum sulfate (wherein the molar ratio of the 3,5-pyridinedicarboxylic acid to the aluminum sulfate was 2:1), obtaining a metal-organic framework (15). The metal-organic framework (15) had a water adsorption amount of 25.3 wt %.

### Preparation Example 16

Preparation Example 16 was performed in the same manner as Preparation Example 1 except that aluminum nitrate was replaced with zirconium oxychloride (ZrOCl₂.8H₂O) (wherein the molar ratio of the 3,5-pyridinedicarboxylic acid to the zirconium oxychloride was 1:1), obtaining a metal-organic framework (16).

### Preparation Example 17

Preparation Example 17 was performed in the same manner as Preparation Example 1 except that aluminum nitrate was replaced with chromium nitrate (Cr(NO₃)₃.9H₂O) (wherein the molar ratio of the 3,5-pyridinedicarboxylic acid to the chromium nitrate was 1:1), obtaining a metal-organic framework (17). The metal-organic framework (17) had a water adsorption amount of 22.05 wt %.

### Comparative Example 1

Comparative Example 1 was performed in the same manner as Preparation Example 1 except that aluminum nitrate was replaced with ferric nitrate (Fe(NO₃)₃. 9H₂O) (wherein the molar ratio of the 3,5-pyridinedicarboxylic acid to the ferric nitrate was 1:1), obtaining a metal-organic framework (18). The metal-organic framework (18) had a water adsorption amount of 0.79 wt %.

### Comparative Example 2

Comparative Example 2 was performed in the same manner as Preparation Example 1 except that aluminum nitrate was replaced with copper nitrate (Cu(NO₃)₂. 3H₂O) (wherein the molar ratio of the 3,5-pyridinedicarboxylic acid to the copper nitrate was 1:1), obtaining a metal-organic framework (19). The metal-organic framework (19) had a water adsorption amount of 0.66 wt %.

### Comparative Example 3

Comparative Example 3 was performed in the same manner as Preparation Example 1 except that 3,5-pyridinedicarboxylic acid was replaced with 2,6-pyridinedicarboxylic acid (wherein the molar ratio of the 2,6-pyridinedicarboxylic acid to the aluminum nitrate was 1:1), obtaining a metal-organic framework (20). The metal-organic framework (20) had a water adsorption amount of 0 wt %.

### Comparative Example 4

Comparative Example 4 was performed in the same manner as Preparation Example 1 except that 3,5-pyridinedicarboxylic acid was replaced with 2,4-pyridinedicarboxylic acid (wherein the molar ratio of the 2,4-pyridinedicarboxylic acid to the aluminum nitrate was 1:1), obtaining a metal-organic framework (21). The metal-organic framework (21) had a water adsorption amount of 9.8 wt %.

### Comparative Example 5

First, aluminum nitrate (0.015 mole), 3,5-pyridinedicarboxylic acid (0.015 mole) and water (90 mL) were mixed, wherein the molar ratio of 3,5-pyridinedicarboxylic acid to the aluminum nitrate was 1:1. Next, the mixture was stirred at 120° C. for 48 hrs. Next, after cooling to room temperature, yellow sediment was collected. After washing the yellow sediment with water and filtering, a yellow solid was obtained. Next, the yellow solid was dried with a dryer (having a drying temperature of about 140° C.) overnight. After drying, the yellow solid was ground into powder. Next, the powder was subjected to a vacuum drying process in a vacuum drying oven, wherein the temperature of the vacuum drying process was about 140° C., and the vacuum drying process was performed for a period of 6 hrs. After cooling to room temperature, no metal-organic framework was obtained.

Table 1 shows the water adsorption amount of the metal-organic frameworks of Preparation Example 1 and Comparative Examples 1-5.

TABLE 1

| | water adsorption amount (wt %) |
|---|---|
| Preparation Example 1 | 34.48 |
| Comparative Example 1 | 0.79 |
| Comparative Example 2 | 0.66 |
| Comparative Example 3 | 0 |
| Comparative Example 4 | 9.8 |
| Comparative Example 5 | No metal-organic framework |
| | was obtained |

As shown in Table 1, the metal-organic frameworks of the disclosure exhibit a water adsorption amount of about 35 wt % when the metal-organic frameworks of the disclosure are prepared from specific ligands (such as 3,5-pyridinedicarboxylic acid) and a suitable metal ion.

Conversely, the metal-organic frameworks (such as the metal-organic frameworks of Comparative Examples 3 and 4) prepared from ligands (such as 2,6-pyridinedicarboxylic acid or 2,4-pyridinedicarboxylic acid), having a similar structure as 3,5-pyridinedicarboxylic acid, exhibit a poor water adsorption amount. Furthermore, when preparing the metal-organic frameworks from an unsuitable metal ion (such as iron ion or copper ion) with specific ligands (such as 3,5-pyridinedicarboxylic acid), the obtained metal-organic frameworks (such as the metal-organic framework of Comparative Examples 1 and 2) exhibit a poor water adsorption amount (less than 1 wt %). In addition, as shown in Comparative Example 5, when the composition only employs water as solvent (i.e. the composition does not include organic solvent), no metal-organic framework can be obtained by subjecting the composition to a heating process.

### Thermogravimetric Analysis (TGA) Curves of Metal-Organic Framework Example 1

### Thermogravimetric Analysis (TGA) Curves of Metal-Organic Framework

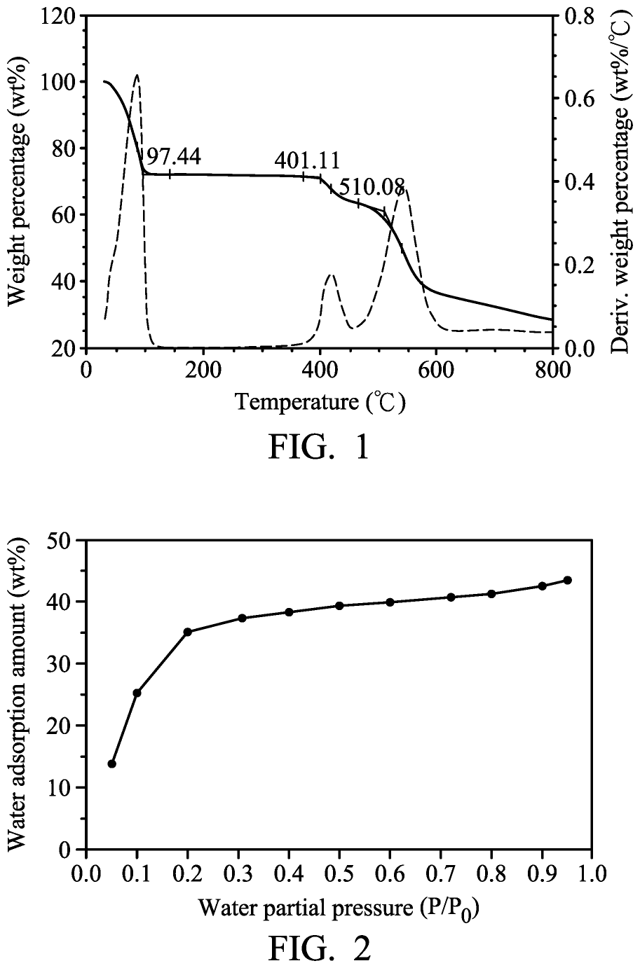

The amount of water desorption and desorption temperature of the metal-organic framework (1) of Preparation Example 1 were determined by thermogravimetric analysis (TGA), and the result is shown in FIG. 1.

The weight loss of the metal-organic framework (1) of Preparation Example 1 (disposed in a thermogravimetric analyzer) was recorded with a heating rate of 10° C./min. As shown in FIG. 1, the weight of the metal-organic framework (1) of Preparation Example 1 was significantly reduced from 50° C. to 100° C. The metal-organic framework (1) had a weight loss of about 30% at 100° C. This means that the metal-organic framework can adsorb water and the water adsorbed by the metal-organic framework can be desorbed at low temperature (about 50° C.). As shown in FIG. 1, the metal-organic framework (1) had a weight loss again until the temperature was raised to about 400° C. This means that the metal-organic framework of the disclosure exhibits high thermal stability (more than 400° C.).

### Isothermal Adsorption Analysis Of Metal-Organic Framework

### Example 2

FIG. 2 shows the isothermal adsorption curve of the metal-organic framework of Preparation Example 1. First, the metal-organic framework of Preparation Example 1 was heated at 80° C. to desorb water under vacuum. Next, the partial pressure of water was gradually increased at 25° C. under vacuum. In detail, 0.1 partial pressure of water was introduced each time. As a result, the metal-organic framework gradually adsorbed water, and then the water adsorption amount of the metal-organic framework was determined at a specific partial pressure of water. As shown in FIG. 2, when the partial pressure of water was increased to 0.2, the water adsorption amount of the metal-organic framework was significantly increased to 35 wt %. The water adsorption amount of the metal-organic framework is increased to 40% with the slow increase of partial pressure of water. This means that the metal-organic framework of the disclosure exhibits a high water adsorption amount under a low relative humidity.

### Adsorption Test Under a Low Relative Humidity

### Example 3

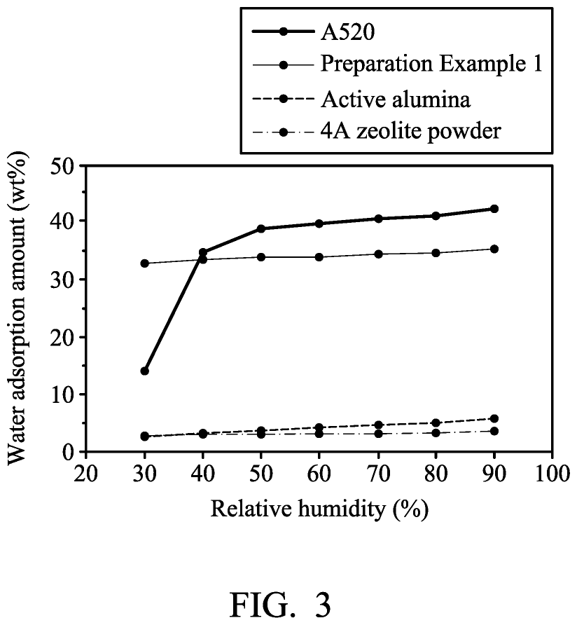

The water adsorption amount of the samples (including the metal-organic framework (1) of Preparation Example 1, an adsorption material (commercially available under the trade name Basolite® A520), an active alumina (commercially available from Eikme International LTD) and zeolite 4A powder (commercially available from Eikme International LTD)) were determined by an adsorption test under a low relative humidity. First, the samples were dried to desorb water at 80° C. for 30 minutes, and then disposed in a constant temperature and humidity chamber at 25° C. under a relative humidity of 30%. After 30 minutes, the water adsorption amounts of the samples were determined. Next, the relative humidity of the constant temperature and humidity chamber was increased to 40%, and then the water adsorption amounts of the samples were determined again after 30 minutes. The above steps are repeated until the relative humidity of the chamber was increased to 90%. The results are shown in FIG. 3. As shown in FIG. 3, the water adsorption amount of the metal-organic framework (1) of Preparation Example 1 can be 33 wt % after disposing the metal-organic framework (1) of Preparation Example 1 in the humidistat under a relative humidity of 30% for 30 minutes. In contrast, the adsorption material (commercially available under the trade name Basolite® A520) had a water adsorption amount of 14 wt % after disposing in the chamber under a relative humidity of 30% for 30 minutes. Therefore, the adsorption material (commercially available under the trade name Basolite® A520) does not exhibit a rapid water adsorption property under a low relative humidity during the same time period. As shown in FIG. 3, the active alumina (conditional adsorption material) and the zeolite 4A powder were dried at 80° C. for 30 minutes to desorb water. Due to the small pore size of the active alumina and the zeolite 4A powder, water adsorbed by the active alumina and the zeolite 4A powder cannot be removed completely at a low temperature (80° C.), resulting in the pores of active alumina and the zeolite 4A powder still filling with water. As a result, the water adsorption amount of the active alumina and the zeolite 4A powder are both less than 6 wt % even though the active alumina and the zeolite 4A powder are disposed in the humidistat under a relative humidity of 90%. This means that those conditional adsorption materials exhibit a poor water adsorption capacity under a low relative humidity.

### Example 4

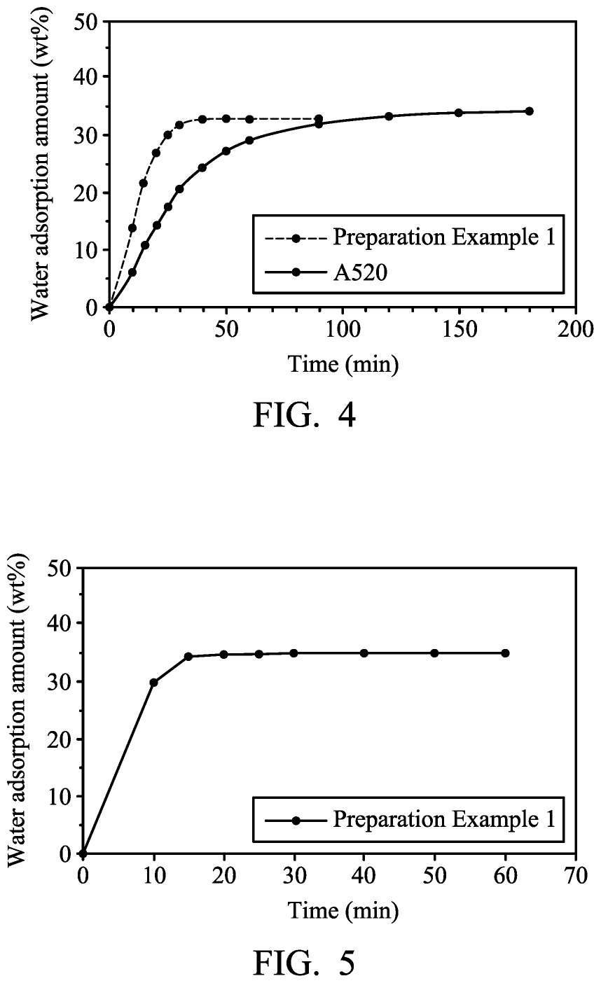

The water adsorption capacity of the metal-organic framework (1) of Preparation Example 1 were compared with that of the adsorption material (commercially available under the trade name Basolite® A520) under a low relative humidity. First, the metal-organic framework (1) of Preparation Example 1 and the adsorption material (commercially available under the trade name Basolite® A520) were dried at 80° C. for 30 minutes. Next, the water adsorption amount of the metal-organic framework (1) of Preparation Example 1 and the adsorption material (commercially available under the trade name Basolite® A520) were determined after disposing these samples in a Constant temperature and humidity chamber at 25° C. under a relative humidity of 30%. As shown in FIG. 4 and Table 2, the metal-organic framework (1) of Preparation Example 1 exhibits a water adsorption amount greater than 30 wt % at 25 minutes. In contrast, the adsorption material (commercially available under the trade name Basolite® A520) exhibits a water adsorption amount about 30 wt % after 60 minutes. This means that the metal-organic framework (1) of Preparation Example 1 can exhibit a rapid water adsorption property under a low relative humidity.

TABLE 2

| | | Adsorption material |
|---|---|---|
| | Preparation | (commercially available under the |
| | Example 1 | tradename Basolite ® A520) |
| Time required for | 25 minutes | 60 minutes |
| achieving the water | | |
| adsorption amount | | |
| of 30 wt % | | |

### Example 5

Example 5 was performed in the same manner as Example 4 except that the relative humidity of the constant temperature and humidity chamber was increased from 30% to 80%, and the result is shown in FIG. 5. As shown in FIG. 5, the metal-organic framework (1) of Preparation Example 1 exhibits a water adsorption amount greater than 30 wt % after 10 minutes and exhibits a water adsorption amount of 34 wt % at 30 minutes. This means that the metal-organic framework (1) of Preparation Example 1 can exhibit a high water adsorption capacity under a high relative humidity.

### Example 6

The metal-organic frameworks of Comparative Examples 1, 3 and 4 were dried at 80° C. for 30 minutes. Next, those samples were disposed in a constant temperature and humidity chamber at 25° C. under a relative humidity of 30%. After 30 minutes, the water adsorption amounts of those samples were determined and the results are shown in Table 3. Next, those samples were disposed in the chamber at 25° C. under a relative humidity of 80%. After 30 minutes, the water adsorption amounts of those samples were determined and the results are shown in Table 3.

TABLE 3

| | Preparation | Comparative | Comparative | Comparative |
|---|---|---|---|---|
| | Example 1 | Example 1 | Example 3 | Example 4 |
| RH 80% for | 34 wt % | 5.43 wt % | 0 | 9.8 wt % |
| 30 minutes | | | | |
| RH 30% for | 33 wt % | 0.79 wt % | 0 | 6.08 wt % |
| 30 minutes | | | | |

As shown in Table 3, the water adsorption amount of the metal-organic framework of Preparation Example 1 is 34 wt % under a relative humidity of 80%. In comparison with Comparative Examples, the water adsorption amount of the metal-organic framework of Preparation Example 1 exhibits a high water adsorption capacity.

Furthermore, the metal-organic framework of the disclosure also exhibits a water adsorption amount of 33 wt % even though the metal-organic framework is used under a low relative humidity (such as 30%).

In view of the examples, the metal-organic framework of the disclosure exhibits high water adsorption amount (greater than 30 wt %) under low and high relative humidity. In addition, water adsorbed by conventional adsorption materials (such as zeolite 4A and active alumina) would be desorbed therefrom at a relative high temperature (about 100° C.). In contrast, water adsorbed by the metal-organic framework of the disclosure can be desorbed therefrom at a relative low temperature (about 80° C.) to regenerate the water adsorption capacity. As a result, the metal-organic framework of the disclosure can adsorb water at low relative humidity and desorb water at low temperatures.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A metal-organic framework, comprising:
a 3,5-pyridinedicarboxylic acid; and
a metal ion, wherein the metal ion is an aluminum ion, a chromium ion, or a zirconium ion, wherein the 3,5-pyridinedicarboxylic acid is coordinated to the metal ion.

2. The metal-organic framework as claimed in claim 1, wherein the molar ratio of 3,5-pyridinedicarboxylic acid to the metal ion is from 3:1 to 1:2.

3. A method for preparing a metal-organic framework, comprising:
providing a composition, wherein the composition comprises a 3,5-pyridinedicarboxylic acid, a metal compound, and an organic solvent; and
subjecting the composition to a heating process so that the 3,5-pyridinedicarboxylic acid reacts with the metal compound, obtaining a metal-organic framework.

4. The method as claimed in claim 3, wherein the molar ratio of 3,5-pyridinedicarboxylic acid to the metal compound is from 3:1 to 1:2.

5. The method as claimed in claim 3, wherein the metal compound is aluminum salt, chromium salt, zirconium salt, or a combination thereof.

6. The method as claimed in claim 3, wherein the metal compound is aluminum nitrate, aluminum phosphate, chromium nitrate, chromium phosphate, zirconium nitrate, zirconium phosphate, zirconyl chloride, or a combination thereof.

7. The method as claimed in claim 3, wherein an initial concentration of the metal compound in the composition is from 0.16 mol/L to 0.33 mol/L.

8. The method as claimed in claim 3, wherein the organic solvent comprises N,N-dimethylformamide, N,N-diethylformamide, N,N-dimethylacetamide, or a combination thereof.

9. The method as claimed in claim 3, wherein the composition further comprises water.

10. The method as claimed in claim 3, wherein the heating process has a temperature from 100° C. to 150° C.

11. The method as claimed in claim 3, wherein the heating process is performed for a period of 12 hrs to 66 hrs.

12. An adsorption device, comprising:
a carrier; and
an adsorption material disposed on the carrier, wherein the adsorption material comprises the metal-organic framework as claimed in claim 1.

13. The adsorption device as claimed in claim 12, wherein the adsorption material has a water adsorption amount of 18 wt % to 40 wt % after disposing the adsorption device at 25° C. under a relative humidity of 30% for 30 minutes.
